(19) United States
(12) Patent Application Publication
(10) Pub. No.: US 2026/0252955 A1
(43) Pub. Date: Aug. 27, 2026

(54) METHOD AND APPARATUS FOR FEDERATED LEARNING

(71) Applicant: ELECTRONICS AND TELECOMMUNICATIONS RESEARCH INSTITUTE, Daejeon (KR)

(72) Inventors: Jihoon Seo, Daejeon (KR); Youngho Suh, Daejeon (KR); Sungpil Woo, Daejeon (KR); Sunhwan Lim, Daejeon (KR)

(21) Appl. No.: 19/371,761

(22) Filed: Oct. 28, 2025

(30) Foreign Application Priority Data
Feb. 20, 2025 (KR) 10-2025-0021892

(51) Int. Cl. G06N 20/00

(52) U.S. Cl. CPC G06N 20/00

(57) ABSTRACT

A method and apparatus for federated learning are provided. The federated learning method includes uploading information of a first initial global artificial intelligence (AI) model to a blockchain network for download by a plurality of local clients, downloading, via the blockchain network, first local training information of the first initial global AI model generated through local training performed by a first local client of the plurality of local clients, updating the first initial global AI model based on the first local training information to generate a first updated global AI model, and uploading global training information of the first updated global AI model to the blockchain network for download by the first local client.

### CROSS-REFERENCE TO RELATED APPLICATION

This application claims the benefit of Korean Patent Application No. 10-2025-0021892, filed on February 20, 2025, in the Korean Intellectual Property Office, the entire disclosure of which is incorporated herein by reference for all purposes.

### BACKGROUND

### 1. Field of the Invention

One or more embodiments relate to a method and apparatus for federated learning.

### 2. Description of the Related Art

Federated learning is a technology in which a plurality of distributed devices locally trains an artificial intelligence (AI) model without exchanging their own data, and a central server aggregates the locally trained models to complete a global AI model. Federated learning facilitates the development and improvement of AI models without collecting data and has gained popularity as a technology that may significantly reduce privacy risks.

### SUMMARY

During a federated learning process, a third party may impersonate a central server or a distributed device or may falsify or contaminate data of the central server or the distributed device. If the data in the federated learning process is falsified or contaminated by a third party, the performance of an AI model generated through federated learning may be degraded.

According to an aspect, there is provided a federated learning method including uploading information of a first initial global artificial intelligence (AI) model to a blockchain network for download by a plurality of local clients, downloading, via the blockchain network, first local training information of the first initial global AI model generated through local training performed by a first local client of the plurality of local clients, updating the first initial global AI model based on the first local training information to generate a first updated global

AI model, and uploading global training information of the first updated global AI model to the blockchain network for download by the first local client.

According to an aspect, there is provided an electronic device including one or more processors and a memory storing instructions executable by the one or more processors, in which the instructions, when executed by the one or more processors, cause the electronic device to upload information of a first initial global AI model to a blockchain network for download by a plurality of local clients, download, via the blockchain network, first local training information of the first initial global AI model generated through local training performed by a first local client of the plurality of local clients, update the first initial global AI model based on the first local training information to generate a first updated global AI model, and upload global training information of the first updated global AI model to the blockchain network for download by the first local client.

According to an aspect, there is provided a federated learning system including a plurality of local clients and a federated server configured to upload information of a first initial global AI model to a blockchain network for download by the plurality of local clients, download, via the blockchain network, first local training information of the first initial global AI model generated through local training performed by a first local client of the plurality of local clients, update the first initial global AI model based on the first local training information to generate a first updated global AI model, and upload global training information of the first updated global AI model to the blockchain network for download by the first local client.

According to embodiments, data may be prevented from being falsified or contaminated by a third party during a federated learning process.

### BRIEF DESCRIPTION OF THE DRAWINGS

FIG. 1A is a diagram illustrating a federated learning process between a federated server and a plurality of local clients according to an embodiment.

FIG. 1B is a diagram illustrating a federated learning process in a local client according to an embodiment.

FIG. 2 is a diagram illustrating a federated learning process via a blockchain network according to an embodiment.

FIG. 3 is a flowchart illustrating a process in which a federated server transmits global training information generated by federated learning to a plurality of local clients according to an embodiment.

FIG. 4 is a flowchart illustrating an operation of a management node of a blockchain network that has received an access right request according to an embodiment.

FIG. 5 is a flowchart illustrating a process in which a management node determines nodes permitted to download uploaded information according to an embodiment.

FIG. 6 is a flowchart illustrating a federated learning process of a federated server according to an embodiment.

FIG. 7 is a block diagram illustrating a configuration of an electronic device for performing federated learning according to an embodiment.

### DETAILED DESCRIPTION

The following detailed structural or functional description is provided as an example only and various alterations and modifications may be made to the examples. Accordingly, the embodiments are not to be construed as limited to the disclosure and should be understood to include all changes, equivalents, or replacements within the idea and the technical scope of the disclosure.

Terms, such as "first", "second", and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is "connected", "coupled", or "joined" to another component, a third component may be "connected", "coupled", and "joined" between the first and second components, although the first component may be directly connected, coupled, or joined to the second component.

The singular forms "a", "an", and "the" are intended to include the plural forms as well, unless the context clearly indicates otherwise. It will be further understood that the terms "comprises/comprising" and/or "includes/including" when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

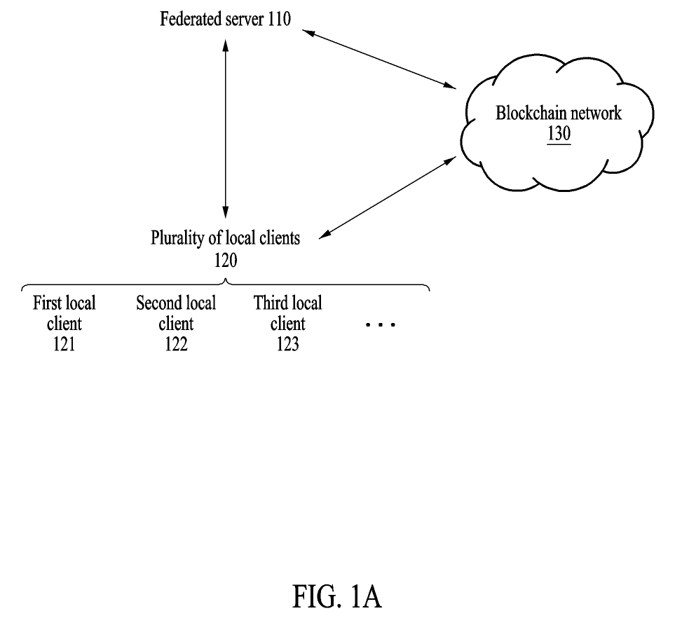

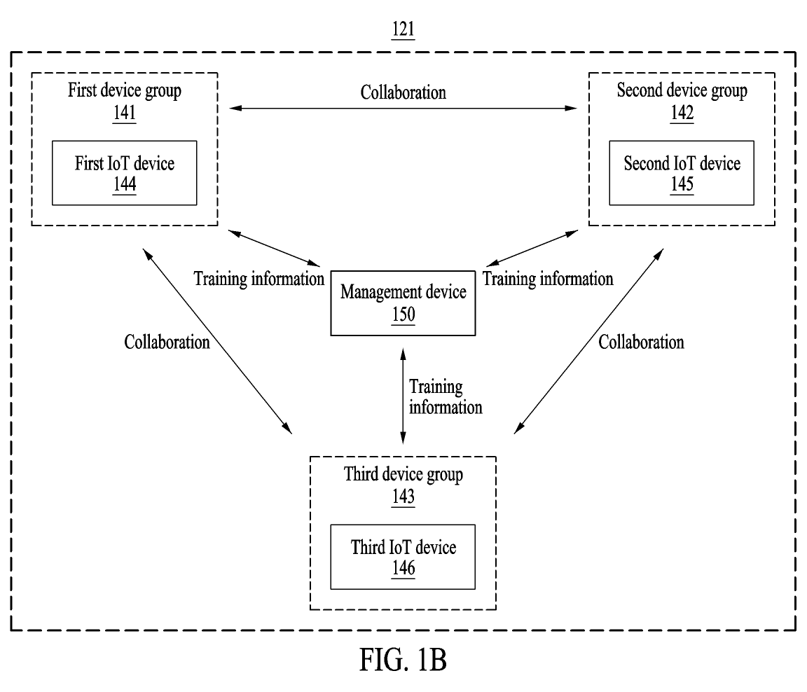

FIG. 1A is a diagram illustrating a federated learning process between a federated server and a plurality of local clients according to an embodiment. Referring to FIG. 1A, a federated server 110 may communicate with a plurality of local clients 120. The federated server 110 may generate one or more initial global artificial intelligence (AI) models. In an embodiment, the one or more initial global AI models may be generated through simulation by any local client of the plurality of local clients 120. An initial global AI model may be an initial AI model used by the plurality of local clients 120. An initial global AI model may be any type of AI model. The federated server 110 may distribute the one or more initial global AI models to the plurality of local clients 120.

The plurality of local clients 120 may include a first local client 121, a second local client 122, and a third local client 123, but the number of local clients included in the plurality of local clients 120 is not limited thereto. Each local client of the plurality of local clients 120 may store local data. The local data of each local client may not be shared with other local clients or with the federated server 110. Each local client may perform training on the initial global AI model distributed by the federated server 110 based on the local data. The training performed by each local client may be referred to as local training.

Each local client of the plurality of local clients 120 may transmit local training information to the federated server 110. For example, the first local client 121, the second local client 122, and the third local client 123 may respectively transmit first local training information, second local training information, and third local training information to the federated server 110. Local training information may be training information of one or more initial global AI models generated through local training of each local client. For example, the first local training information, the second local training information, and the third local training information may be training information for one or more initial global AI models generated by the first local client 121, the second local client 122, and the third local client 123, respectively. In an embodiment, the training information of each local client of the plurality of local clients 120 may be a locally trained AI model. In an embodiment, the training information of each local client of the plurality of local clients 120 may be weights of a locally trained AI model.

The federated server 110 may perform global training on one or more initial global AI models based on the local training information transmitted by the plurality of local clients 120. The federated server 110 may update the one or more initial global AI models through global training. The federated server 110 may generate one or more updated global AI models. The federated server 110 may distribute global training information of the one or more updated global AI models to the plurality of local clients 120. In an embodiment, the global training information may be the one or more updated global AI models. In an embodiment, the global training information may be weights of the one or more updated global AI models.

A federated learning process may be exposed to a malicious attack. A malicious attack may refer to a case where a malicious attacker (a third party) manipulates data or contaminates a model to degrade the performance of a global AI model during a federated learning process. For example, the malicious attacker may impersonate a local client to receive a global AI model and may transmit the global AI model to a federated server after contaminating the global AI model. In addition, for example, the malicious attacker may manipulate local training information generated by a normal local client and may transmit the manipulated information to the federated server. If a malicious attack occurs, the performance of the global AI model resulting from federated learning may be degraded, and a local client may use the AI model with degraded performance. Since federated learning does not share local data, it may be difficult to determine whether data received during a federated learning process corresponds to a malicious attack.

To prevent a malicious attack during a federated learning process, a blockchain network 130 may be used for communication between the federated server 110 and the plurality of local clients 120. The federated server 110 may distribute one or more initial global AI models and global training information to the plurality of local clients 120 via the blockchain network 130. The plurality of local clients 120 may transmit local training information to the federated server 110 via the blockchain network 130.

FIG. 1B is a diagram illustrating a federated learning process in a local client according to an embodiment. Referring to FIG. 1B, the first local client 121 may include a plurality of Internet of Things (IoT) devices. An IoT device may be a device connected to the Internet to collect, transmit, or analyze data, or to be remotely controlled. The first local client 121 may include a first IoT device 144, a second IoT device 145, and a third IoT device 146, but the number of IoT devices of the first local client 121 is not limited thereto.

The first IoT device 144, the second IoT device 145, and the third IoT device 146 may respectively correspond to a first device group 141, a second device group 142, and a third device group 143. The first device group 141, the second device group 142, and the third device group 143 may be device groups necessarily and/or commonly included in each local client according to a purpose of the local client. For example, if each local client corresponds to an autonomous driving vehicle, the first device group 141, the second device group 142, and the third device group 143 may respectively be a sensor device group for sensing objects, a navigation device group for determining a vehicle position, and a steering device group for controlling the vehicle.

Each local client of the plurality of local clients 120 may correspond to Artificial Intelligence of Things (AIoT). AIoT may refer to a system in which one or more IoT devices collect data, and an AI model of an IoT device performs inference based on the collected data. The federated server 110 may distribute one or more initial global AI models for a plurality of IoT devices to the plurality of local clients 120. For example, the one or more initial global AI models may include a first initial global AI model, a second initial global AI model, and a third initial global AI model. For example, the first initial global AI model, the second initial global AI model, and the third initial global AI model may respectively correspond to the first device group 141, the second device group 142, and the third device group 143.

Each local client of the plurality of local clients 120 may include a management device for managing federated learning. For example, the first local client 121 may include a management device 150. The management device may receive one or more initial global AI models generated by the federated server 110. The management device 150 may assign an appropriate AI model to a plurality of IoT devices. For example, the management device 150 may assign an AI model for performing a humidification task to the first IoT device 144 under a dry condition or may assign an AI model for performing a dehumidification task to the first IoT device 144 under a humid condition.

In an embodiment, the management device may dynamically reconfigure an AI model distributed by the federated server 110 according to characteristics of an IoT device of a local client. For example, the management device 150 may reconfigure a first initial global AI model, a second initial global AI model, and a third initial global AI model based on sensors and/or actuators of the first IoT device 144, the second IoT device 145, and the third IoT device 146. The management device may transmit a reconfigured AI model to a plurality of IoT devices. For example, the management device 150 may transmit the reconfigured first, second, and third initial global AI models to the first IoT device 144, the second IoT device 145, and the third IoT device 146.

A plurality of IoT devices of each local client of the plurality of local clients 120 may collaborate with each other. For example, the first IoT device 144, the second IoT device 145, and the third IoT device 146 of the first local client 121 may collaborate with each other. A plurality of IoT devices may perform local training through collaboration. In an embodiment, a plurality of IoT devices may transmit local training information generated through local training to a management device. In an embodiment, a management device may generate local training information based on local training results received from a plurality of IoT devices.

A management device of each local client of the plurality of local clients 120 may transmit local training information to the federated server 110. For example, the management device 150 may transmit the training information of the first local client 121 to the federated server 110. A management device of each local client of the plurality of local clients 120 may receive global training information. A management device of each local client of the plurality of local clients 120 may distribute global training information to a plurality of IoT devices. For example, the management device 150 may respectively distribute global training information corresponding to the first initial global AI model, the second initial global AI model, and the third initial global AI model to the first IoT device 144, the second IoT device 145, and the third IoT device 146.

In an embodiment, to prevent a malicious attack, a blockchain network may be used for communication between a management device and a plurality of IoT devices. For example, the management device 150 may distribute first global training information corresponding to the first initial global AI model to the first IoT device 144 via the blockchain network.

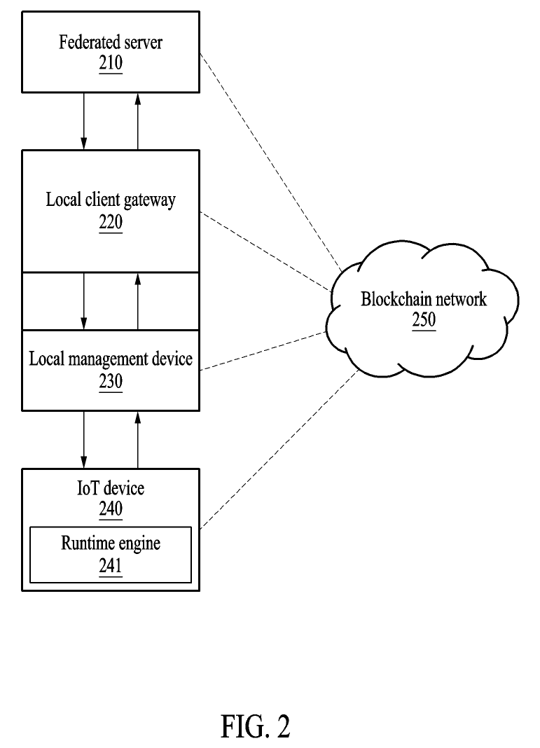

FIG. 2 is a diagram illustrating a federated learning process via a blockchain network according to an embodiment. Referring to FIG. 2, a federated server 210, a local client gateway 220, a local management device 230, and an IoT device 240 may transmit and receive data via a blockchain network 250. The federated server 210 may distribute an initial global AI model and/or an updated global AI model to the local client gateway 220 via the blockchain network 250. The federated server 210 may receive local training information from the local client gateway 220 via the blockchain network 250. The federated server 210 may correspond to the federated server 110 illustrated in FIG. 1A.

The local client gateway 220 may store and/or manage information of an initial AI model and/or an updated AI model distributed from the federated server 210. The local client gateway 220 may optimize a local AI model by comparing a locally trained AI model with the updated AI model received from the federated server 210. For example, the local client gateway 220 may optimize the local AI model according to one of entirely accepting, partially accepting, or completely ignoring the updated AI model.

The local client gateway 220 may transmit an initial AI model and/or an optimized AI model to the local management device 230 via the blockchain network 250. The local management device 230 may assign an AI model to the IoT device 240 via the blockchain network 250. The local client gateway 220, the local management device 230, and the IoT device 240 may correspond to each local client of the plurality of local clients 120 of FIG. 1A. The blockchain network 250 may correspond to the blockchain network 130 of FIG. 1A.

In an embodiment, the IoT device 240 may include a runtime engine 241. The runtime engine 241 may dynamically reconfigure an AI model received from the local management device 230 according to characteristics of the IoT device 240. The IoT device 240 may transmit local training results of the AI model to the local management device 230 via the blockchain network 250. The local management device 230 may transmit local training information to the local client gateway 220 via the blockchain network 250. Exchange of AI model information and/or training information via the blockchain network 250 may prevent a malicious attack in a federated learning process.

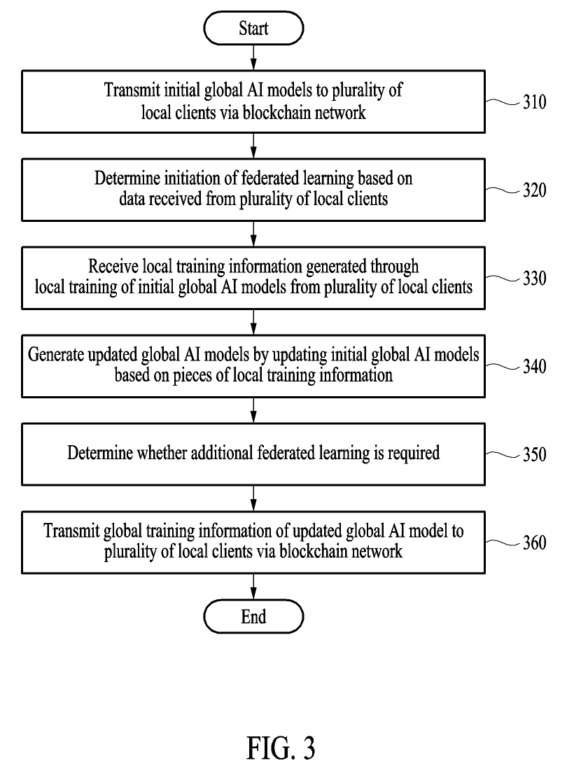

FIG. 3 is a flowchart illustrating a process in which a federated server transmits global training information generated by federated learning to a plurality of local clients according to an embodiment. Referring to FIG. 3, in operation 310, the federated server may transmit initial global AI models to the plurality of local clients via a blockchain network. The federated server and the plurality of local clients may respectively correspond to the federated server 110 and the plurality of local clients 120 of FIG. 1A. The blockchain network may correspond to the blockchain network 130 of FIG. 1A. The blockchain network may include a plurality of nodes. The plurality of nodes may include the federated server and/or the plurality of local clients.

The federated server may upload information of an initial global AI model to the blockchain network such that the plurality of local clients may download the information. Before uploading the initial global AI model, the blockchain network may verify an access right of the federated server to determine whether the federated server is a malicious attacker.

In an embodiment, the information of an initial global AI model may be the initial global AI model. For example, a transaction of a block of the blockchain network may include data of the initial global AI model converted into Base 64 or binary form. In an embodiment, the information of an initial global AI model may be a location and/or access method through which the initial global AI model may be downloaded. For example, the initial global AI model may be stored in an interplanetary file system (IPFS), a distributed storage, or a cloud. For example, a transaction of a block of the blockchain network may include a hash value corresponding to the initial global AI model stored in the IPFS.

After uploading the information of an initial global AI model, the federated server may transmit a download request for the information of the initial global AI model to the plurality of local clients. Each local client of the plurality of local clients may confirm the information of the initial global AI model via the blockchain network. Before confirming the information of the initial global AI model, the blockchain network may verify an access right of each local client of the plurality of local clients to determine whether each local client of the plurality of local clients is a malicious attacker. Each local client of the plurality of local clients may download the initial global AI model based on the information of the initial global AI model. The plurality of local clients may perform local training on the downloaded initial global AI model.

In operation 320, the federated server may determine initiation of federated learning based on data received from the plurality of local clients. In an embodiment, the federated server may initiate federated learning on a time basis. In an embodiment, the federated server may receive performance metrics of an AI model from the plurality of local clients. The federated server may initiate federated learning based on the metrics of a performance criterion. For example, if a mean task success rate of a local AI model received from the plurality of local clients is 80% or more, the federated server may initiate federated learning. In an embodiment, the federated server may receive distribution data of local data from the plurality of local clients. The federated server may initiate federated learning based on the distribution data. For example, if a change in a ratio of the distribution data is greater than or equal to a predetermined ratio, the federated server may initiate federated learning.

In operation 330, the federated server may receive local training information generated through local training of initial global AI models from the plurality of local clients. The plurality of local clients may upload local training information to the blockchain network. Before uploading the local training information, the blockchain network may verify an access right of each local client of the plurality of local clients to determine whether each local client of the plurality of local clients is a malicious attacker. The plurality of local clients may transmit a download request for local training information to the federated server. The federated server may confirm local training information via the blockchain network. In an embodiment, the local training information may be weights of a locally trained AI model. In an embodiment, the local training information may be a location and/or access method through which the weights of a locally trained AI model may be downloaded.

The federated server may download, via the blockchain network, local training information of an initial global AI model generated through local training of each local client of the plurality of local clients. For example, the federated server may download, via the blockchain network, first local training information of the initial global AI model generated through local training of a first local client of the plurality of local clients. For example, the federated server may download second local training information of the initial global AI model generated through local training of a second local client of the plurality of local clients via the blockchain network. Before confirming local training information, the blockchain network may verify an access right of the federated server to determine whether the federated server is a malicious attacker.

In operation 340, the federated server may generate updated global AI models by updating initial global AI models based on pieces of local training information. For example, the federated server may update an initial global AI model based on first local training information and second local training information and generate an updated global AI model. Through verification by the blockchain network, the federated server may update initial global AI models without intervention by a malicious attacker.

In operation 350, the federated server may determine whether additional federated learning is required. The federated server may evaluate performance of an updated global AI model. For example, the federated server may evaluate a task success rate of the updated global AI model based on global data stored in the federated server. The federated server may compare performance of an AI model before and after update. The federated server may determine whether additional federated learning is required based on the evaluated performance of the updated global AI model. When it is determined that additional federated learning is required, the process may return to operation 330.

In operation 360, the federated server may transmit global training information of an updated global AI model to the plurality of local clients via the blockchain network. The federated server may upload information of an updated global AI model to the blockchain network such that the plurality of local clients may download the information. Before uploading the updated global AI model, the blockchain network may verify an access right of the federated server to determine whether the federated server is a malicious attacker.

In an embodiment, information of an updated global AI model may be weights resulting from global training. In an embodiment, the information of an updated global AI model may be a location and/or access method through which the weights of the updated global AI model may be downloaded. For example, the weights of the updated global AI model may be stored in an IPFS, a distributed storage, or a cloud. For example, a transaction of a block of the blockchain network may include a hash value corresponding to the weights of the updated global AI model stored in the IPFS.

After uploading information of an updated global AI model, the federated server may transmit a download request for the information of the updated global AI model to the plurality of local clients. Each local client of the plurality of local clients may confirm the information of the updated global AI model via the blockchain network. Before confirming the information of the updated global AI model, the blockchain network may verify an access right of each local client of the plurality of local clients to determine whether each local client of the plurality of local clients is a malicious attacker.

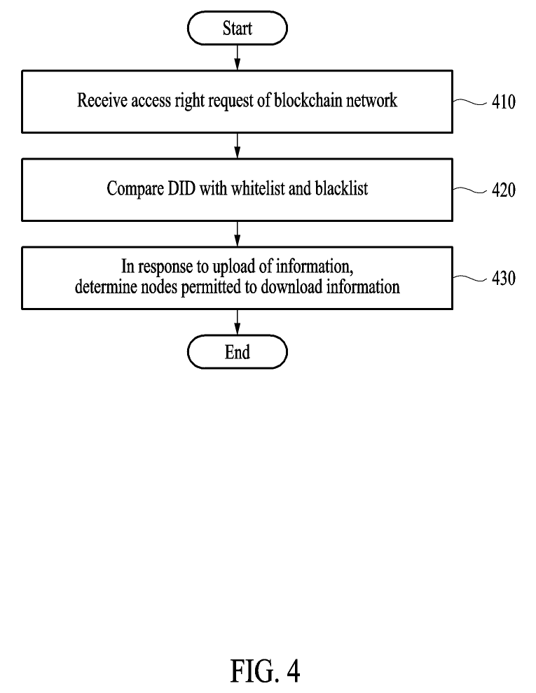

FIG. 4 is a flowchart illustrating an operation of a management node of a blockchain network that has received an access right request according to an embodiment. Referring to FIG. 4, in operation 410, the management node may receive an access right request of the blockchain network. The management node may be one of a plurality of nodes of the blockchain network. The blockchain network may correspond to the blockchain network 130 of FIG. 1A. The management node may be one of nodes for managing and/or verifying an access right to the blockchain network. In an embodiment, the management node may be a federated server. In an embodiment, the management node may be a local client of a plurality of local clients.

For any node of the blockchain network to upload data to a blockchain network, an access right to the blockchain network may be required. The access right may be an access right to write a specific transaction on the blockchain network. The management node may verify and/or approve an access right to write a specific transaction for one of a plurality of nodes of the blockchain network.

For example, to upload information of an initial global AI model and/or global training information, the federated server may request an access right to the blockchain network from the management node. The management node may receive a request for an access right to upload information of an initial global AI model and/or global training information from the federated server. For example, to upload local training information, each local client of the plurality of local clients may request an access right to the blockchain network from the management node. The management node may receive a request for an access right to upload local training information of each local client of the plurality of local clients.

In operation 420, the management node may compare a decentralized identity (DID) with a whitelist and a blacklist. The management node may compare the DID with the whitelist and the blacklist to verify the access right request received in operation 410. The DID may refer to a digital identity owned by an individual rather than by a central authority. The DID may be associated with a verifiable credential issued by a trusted authority. The whitelist may be a list that records DIDs of all nodes included in the blockchain network. The blacklist may be a list that records users who are highly likely to be malicious.

The management node may receive a DID of a node having requested writing of a specific transaction on the blockchain network. The management node may compare a DID of a node having requested an access right with the whitelist. If a DID of a specific node is recorded on the whitelist, the management node may determine that the node is a trusted node. The management node may compare a DID of a node having requested an access right with the blacklist. If a DID of a specific node is recorded on the blacklist, even if the same DID is recorded on the whitelist, the management node may determine that the node is an untrusted node. In an embodiment, the management node may determine whether the node having requested an access right is a trusted node by comparing a reputation score with a threshold score. In an embodiment, a process in which the management node compares a DID with the whitelist and the blacklist may be implemented as a smart contract.

The management node may approve an access right of a trusted node. Upon approval of an access right of the federated server, the federated server may upload information of an initial global AI model and/or global training information to the blockchain network. Upon approval of an access right of the federated server, each local client may upload local training information to the blockchain network.

In operation 430, the management node, in response to the upload of information, may determine nodes permitted to download the information. The management node, in response to the writing of a specific transaction including the information, may determine nodes that may access the transaction. The process in which the management node determines nodes that may write a transaction on the blockchain network may differ from the process in which the management node determines nodes permitted to read a transaction written on the blockchain network.

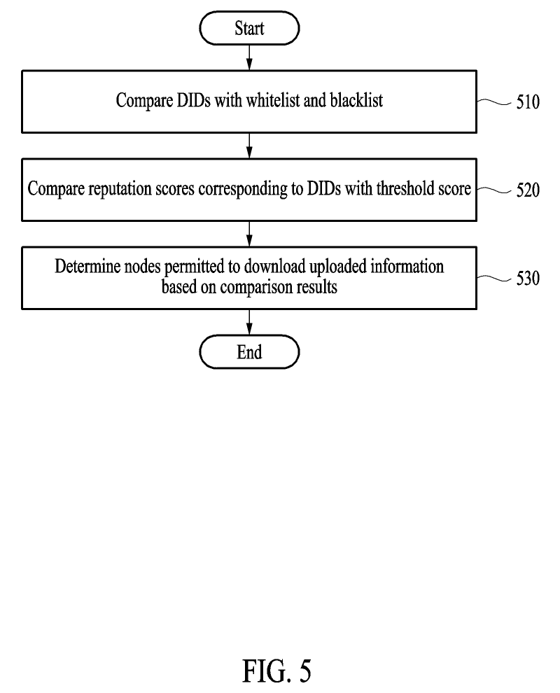

FIG. 5 is a flowchart illustrating a process in which a management node determines nodes permitted to download uploaded information according to an embodiment. Referring to FIG. 5, in operation 510, the management node may compare DIDs with a whitelist and a blacklist. A DID, the whitelist, and the blacklist may respectively correspond to the DID, the whitelist, and the blacklist described with reference to FIG. 4. In an embodiment, the whitelist may be a list of predetermined nodes corresponding to a node having uploaded information to a blockchain. For example, if a node having uploaded information is a federated server, nodes on the whitelist may correspond to a plurality of local clients. The whitelist may be recorded in a transaction uploaded to the blockchain, which is a list of nodes permitted to read the transaction.

In operation 520, the management node may compare reputation scores corresponding to DIDs with a threshold score. The management node of the blockchain network may record and/or manage reputation scores of nodes on the blockchain network. The management node of the blockchain network may change reputation scores of nodes corresponding to a transaction written by nodes on the blockchain network. The management node may evaluate a transaction written by nodes on the blockchain network. In an embodiment, the management node may evaluate a transaction written by nodes using a transaction evaluation AI model. In an embodiment, a process in which the management node determines whether a transaction written by nodes corresponds to a normal activity and/or a malicious activity may be implemented as a smart contract.

If a transaction written by nodes on the blockchain network corresponds to a normal activity, the management node may increase reputation scores of these nodes. If a transaction written by nodes on the blockchain network corresponds to a malicious activity, the management node may decrease reputation scores of these nodes. In an embodiment, if a reputation score of a specific node is lower than the threshold score, the management node may add a DID of the node to the blacklist.

In operation 530, the management node may determine nodes permitted to download uploaded information based on comparison results. The management node may determine nodes permitted to download uploaded information based on the comparison results in operations 510 and 520. If a DID of a specific node is recorded on the whitelist, the management node may determine the node to be a node permitted to download uploaded information. The management node may compare a DID of a node having requested an access right with the blacklist. If a DID of a specific node is recorded on the blacklist, even if the same DID is recorded on the whitelist, the management node may determine the node to be a node not permitted to download uploaded information.

If a reputation score of a specific node is lower than the threshold score, the node may be determined to be a node not permitted to download uploaded information. Even if a specific node is determined to be a node not permitted to download uploaded information based on the comparison result in operation 510, if a reputation score of the node is lower than the threshold score, the node may ultimately be determined to be a node not permitted to download uploaded information.

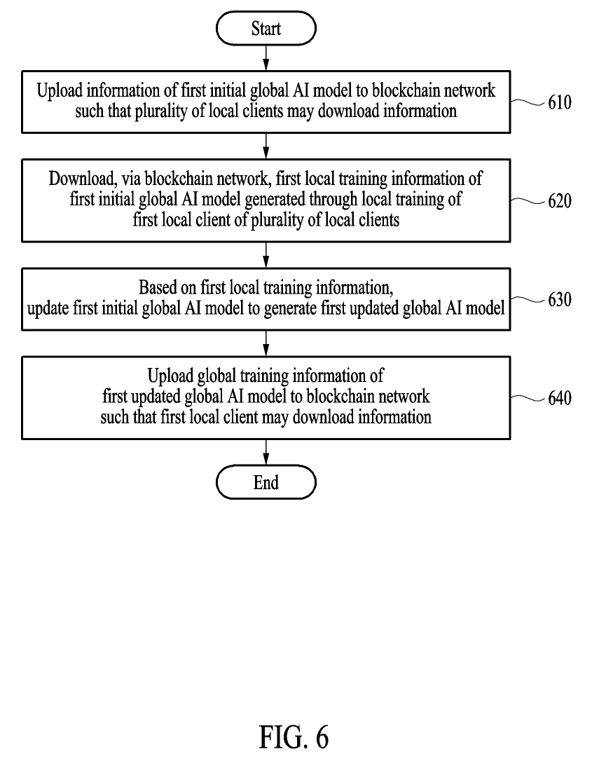

FIG. 6 is a flowchart illustrating a federated learning process of a federated server according to an embodiment. In operation 610, the federated server may upload information of a first initial global AI model to a blockchain network such that a plurality of local clients may download the information. The federated server may request an access right to the blockchain network from a management node of the blockchain network. Upon approval of the access right by the management node, the federated server may upload the information of the first initial global AI model to the blockchain network.

In response to the upload of information of the first initial global AI model, the management node may compare DIDs of the plurality of local clients with a whitelist, which is a list of trusted clients, and a blacklist, which is a list of untrusted clients, compare reputation scores of the plurality of local clients with a threshold score, and determine, based on comparison results, clients permitted to download the first initial global AI model among the plurality of local clients. The information of the first initial global AI model may include a hash value corresponding to the first initial global AI model stored in an IPFS. A first local client may include a plurality of IoT devices and may transmit, via the blockchain network, the information of the first initial global AI model to a first IoT device of the plurality of IoT devices. The first initial global AI model may be an AI model corresponding to the first IoT device.

In operation 620, the federated server may download, via the blockchain network, first local training information of the first initial global AI model generated through local training of the first local client of the plurality of local clients. The federated server may also download, via the blockchain network, the first local training information of the first initial global AI model generated through local training of the first local client and second local training information of the first initial global AI model generated through local training of the second local client of the plurality of local clients.

In operation 630, the federated server, based on the first local training information, may update the first initial global AI model to generate a first updated global AI model. The federated server, based on the first local training information and the second local training information, may update the first initial global AI model to generate a first updated global AI model.

In operation 640, the federated server may upload global training information of the first updated global AI model to the blockchain network such that the first local client may download the information. The federated server may request an access right to the blockchain network from the management node of the blockchain network. Upon approval of the access right by the management node, the federated server may upload the global training information to the blockchain network.

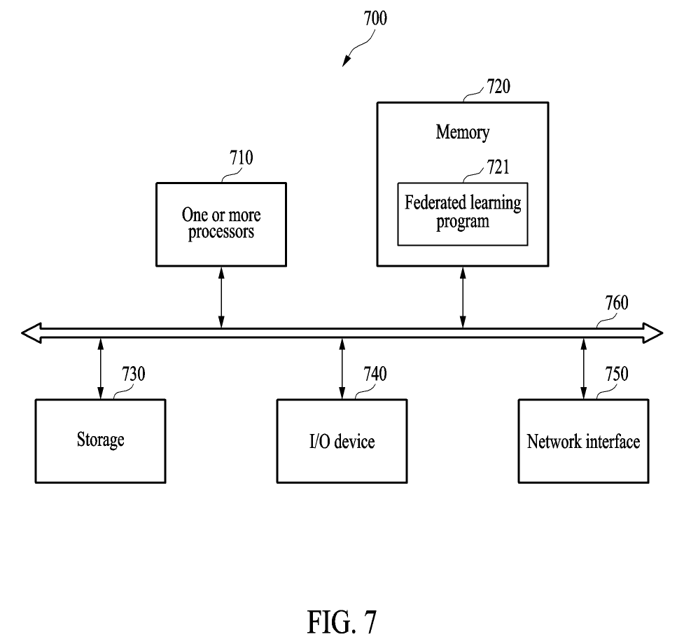

FIG. 7 is a block diagram illustrating a configuration of an electronic device for performing federated learning according to an embodiment. Referring to FIG. 7, an electronic device 700 may include one or more processors 710, a memory 720, a storage 730, an input/output (I/O) device 740, and a network interface 750. These components may communicate with each other via a communication bus 760. For example, the electronic device 700 may be implemented as at least some of a mobile device, such as a mobile phone, a smartphone, a personal digital assistant (PDA), a netbook, a tablet computer, or a laptop computer, a wearable device, such as a smartwatch, a smart band, or smart glasses, a home appliance, such as a television (TV), a smart TV, or a refrigerator, a security device, such as a door lock, and a vehicle, such as an autonomous vehicle, or a smart vehicle.

The one or more processors 710 may execute instructions stored in the memory 720 or the storage 730. When executed by the one or more processors 710, the instructions may cause the electronic device 700 to perform the operations described with reference to FIGS. 1 to 6. The memory 720 may include a non-transitory computer-readable storage medium or a non-transitory computer-readable storage device. The memory 720 may store instructions to be executed by the one or more processors 710 and may store related information while software and/or an application is being executed by the electronic device 700. The memory 720 may store a federated learning program 721 for updating a global model based on local data of an embodiment. When at least a portion of the federated learning program 721 is stored in the memory 720, the operations described with reference to FIGS. 1 to 6 may be performed by the electronic device 700.

The storage 730 may include a computer-readable storage medium or a computer-readable storage device. The storage 730 may store a more quantity of information than the memory 720 for a long time. For example, the storage 730 may include a magnetic hard disk, an optical disc, a flash memory, a floppy disk, or other non-volatile memories known in the art.

The I/O device 740 may receive an input from the user in traditional input manners through a keyboard and a mouse, and in new input manners, such as a touch input, a voice input, and an image input. For example, the I/O device 740 may include a keyboard, a mouse, a touch screen, a microphone, or any other device that detects the input from the user and transmits the detected input to the electronic device 700. The I/O device 740 may provide an output of the electronic device 700 to the user through a visual, auditory, or haptic channel.

The I/O device 740 may include, for example, a display, a touch screen, a speaker, a vibration generator, or any other device that provides the output to the user. The network interface 750 may communicate with an external device through a wired or wireless network.

The examples described herein may be implemented by using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing unit also may access, store, manipulate, process, and generate data in response to execution of the software. For purpose of simplicity, the description of a processing device is used as singular; however, one skilled in the art will appreciate that a processing device may include multiple processing elements and multiple types of processing elements. For example, the processing unit may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Accordingly, other implementations are within the scope of the following claims.

What is claimed is:

1. A federated learning method comprising:
uploading information of a first initial global artificial intelligence (AI) model to a blockchain network for download by a plurality of local clients;
downloading, via the blockchain network, first local training information of the first initial global AI model generated through local training performed by a first local client of the plurality of local clients;
updating the first initial global AI model based on the first local training information to generate a first updated global AI model; and
uploading global training information of the first updated global AI model to the blockchain network for download by the first local client.

2. The federated learning method of claim 1, wherein the downloading of the first local training information comprises:
downloading, via the blockchain network, the first local training information and second local training information of the first initial global AI model generated through local training performed by a second local client of the plurality of local clients; and
the generating of the first updated global AI model comprises:
updating the first initial global AI model based on the first local training information and the second local training information to generate the first updated global AI model.

3. The federated learning method of claim 1, wherein the uploading of the information of the first initial global AI model comprises:
requesting an access right to the blockchain network from a management node of the blockchain network; and
uploading, upon approval of the access right by the management node, the information of the first initial global AI model to the blockchain network.

4. The federated learning method of claim 3, wherein the management node, in response to the uploading of the information of the first initial global AI model, is configured to:
compare decentralized identities (DIDs) of the plurality of local clients with a whitelist, which is a list of trusted clients, and a blacklist, which is a list of untrusted clients;
compare reputation scores of the plurality of local clients with a threshold score; and
determine, based on comparison results, clients of the plurality of local clients that are permitted to download the first initial global AI model.

5. The federated learning method of claim 3, wherein the information of the first initial global AI model comprises:
a hash value corresponding to the first initial global AI model stored in an interplanetary file system (IPFS).

6. The federated learning method of claim 1, wherein the first local client comprises a plurality of Internet of Things (IoT) devices and is configured to transmit, via the blockchain network, the information of the first initial global AI model to a first IoT device of the plurality of IoT devices; and
the first initial global AI model is an AI model corresponding to the first IoT device.

7. The federated learning method of claim 1, wherein the uploading of the global training information comprises:
requesting an access right to the blockchain network from a management node of the blockchain network; and
uploading, upon approval of the access right by the management node, the global training information to the blockchain network.

8. An electronic device comprising:
one or more processors; and
a memory storing instructions executable by the one or more processors,
wherein the instructions, when executed by the one or more processors, cause the electronic device to:
upload information of a first initial global artificial intelligence (AI) model to a blockchain network for download by a plurality of local clients;
download, via the blockchain network, first local training information of the first initial global AI model generated through local training performed by a first local client of the plurality of local clients;
update the first initial global AI model based on the first local training information to generate a first updated global AI model; and
upload global training information of the first updated global AI model to the blockchain network for download by the first local client.

9. The electronic device of claim 8, wherein the instructions, when executed by the one or more processors, cause the electronic device to:
for the downloading of the first local training information,
download, via the blockchain network, the first local training information and second local training information generated through local training performed by a second local client on the first initial global AI model; and
for the generating of the first updated global AI model,
update the first initial global AI model based on the first local training information and the second local training information to generate the first updated global AI model.

10. The electronic device of claim 8, wherein the instructions, when executed by the one or more processors, cause the electronic device to:
for the uploading of the information of the first initial global AI model,
request an access right to the blockchain network from a management node of the blockchain network; and
upload, upon approval of the access right by the management node, the information of the first initial global AI model to the blockchain network.

11. The electronic device of claim 10, wherein the management node, in response to the uploading of the information of the first initial global AI model, is configured to:
compare decentralized identities (DIDs) of the plurality of local clients with a whitelist, which is a list of trusted clients, and a blacklist, which is a list of untrusted clients;
compare reputation scores of the plurality of local clients with a threshold score; and
determine, based on comparison results, clients of the plurality of local clients that are permitted to download the first initial global AI model.

12. The electronic device of claim 10, wherein the information of the first initial global AI model comprises:
a hash value corresponding to the first initial global AI model stored in an interplanetary file system (IPFS), and access right information.

13. The electronic device of claim 8, wherein the first local client comprises a plurality of Internet of Things (IoT) devices and is configured to transmit, via the blockchain network, the information of the first initial global AI model to a first IoT device of the plurality of IoT devices; and
the first initial global AI model is an AI model corresponding to the first IoT device.

14. The electronic device of claim 8, wherein the instructions, when executed by the one or more processors, cause the electronic device to:
for the uploading of the global training information,
request an access right to the blockchain network from a management node of the blockchain network; and
upload, upon approval of the access right by the management node, the global training information to the blockchain network.

15. A federated learning system comprising:
a plurality of local clients; and
a federated server configured to:
upload information of a first initial global artificial intelligence (AI) model to a blockchain network for download by the plurality of local clients;
download, via the blockchain network, first local training information of the first initial global AI model generated through local training performed by a first local client of the plurality of local clients;
update the first initial global AI model based on the first local training information to generate a first updated global AI model; and
upload global training information of the first updated global AI model to the blockchain network for download by the first local client.

16. The federated learning system of claim 15, wherein the federated server is configured to:
for the downloading of the first local training information,
download, via the blockchain network, the first local training information and second local training information generated through local training performed by a second local client on the first initial global AI model; and
for the generating of the first updated global AI model,
update the first initial global AI model based on the first local training information and the second local training information to generate the first updated global AI model.

17. The federated learning system of claim 15, wherein the federated server is configured to:
for the uploading of the information of the first initial global AI model,
request an access right to the blockchain network from a management node of the blockchain network; and
upload, upon approval of the access right by the management node, the information of the first initial global AI model to the blockchain network.

18. The federated learning system of claim 17, wherein the management node, in response to the uploading of the information of the first initial global AI model, is configured to:
compare decentralized identities (DIDs) of the plurality of local clients with a whitelist, which is a list of trusted clients, and a blacklist, which is a list of untrusted clients;
compare reputation scores of the plurality of local clients with a threshold score; and
determine, based on comparison results, clients of the plurality of local clients that are permitted to download the first initial global AI model.

19. The federated learning system of claim 18, wherein the information of the first initial global AI model comprises:
a hash value corresponding to the first initial global AI model stored in an interplanetary file system (IPFS).

20. The federated learning system of claim 15, wherein the first local client comprises a plurality of Internet of Things (IoT) devices and is configured to transmit, via the blockchain network, the information of the first initial global AI model to a first IoT device of the plurality of IoT devices; and
the first initial global AI model is an AI model corresponding to the first IoT device.
